(19) United States
(12) Patent Application Publication
(10) Pub. No.: US 2007/0185241 A1
(43) Pub. Date: Aug. 9, 2007

(54) High build coating composition and coatings formed therefrom

(76) Inventors: Scott M. Schutts, Menomonie, WI (US); Ronald J. Israelson, Lake Elmo, MN (US)

Correspondence Address: 3M INNOVATIVE PROPERTIES COMPANY, PO BOX 33427, ST. PAUL, MN, 55133-3427, US

(21) Appl. No.: 11/703,337

(22) Filed: Feb. 6, 2007

Related U.S. Application Data
(60) Provisional application No. 60/765,523, filed on Feb. 6, 2006.
(60) Provisional application No. 60/882,790, filed on Dec. 29, 2006.

(51) Int. Cl. C08J 9/32

(52) U.S. Cl. 523/218

(57) ABSTRACT

High build coating composition comprising reactive resin and plurality of microspheres.

### CROSS REFERENCE

This application claims priority to U.S. Provisional Patent Application No. 60/765,523, filed Feb. 6, 2006, and U.S. Provisional Patent Application No. 60/882,790, filed Dec. 29, 2006. Both of these applications are incorporated herein by reference in their entirety.

### FIELD OF INVENTION

The present invention relates to high build coating compositions that can be used to form protective coatings, insulative materials, etc. on desired surfaces. They are particularly useful for forming high build coatings on motor vehicles, e.g., in situ bed liners on trucks, void filler, etc.

### BACKGROUND

In recent years it has been known to use reactive polyurethane compositions and polyurea compositions to form protective coatings on desired surfaces, e.g., vehicle body parts. Such compositions are typically applied by such methods as spraying to in multiple coats to form resultant coatings of desired thickness. Such applications are sometimes referred to as “high build coatings”. Illustrative applications for such coatings include interior or exterior coatings on vehicles, coatings on pipelines, bridges, radio towers, and other metal work structures.

Deficiencies of previously known coatings include lower insulative properties than may be desired, a tendency to exhibit poor adhesion to overlying paint coatings, and undesirably high weight.

### SUMMARY OF INVENTION

The present invention provides improved high build coatings and method for forming such coatings.

The coatings of the present invention provide improved insulative properties, improved adhesion to overlying paint coatings. Materials of the invention can be used, for example, as bed liners on trucks, void fillers within vehicle bodies and frames, and fire wall insulation as well as coatings on pipelines, bridges, radio towers, and other metal work structures.

In brief summary, the material of the invention comprises an insulative body for a vehicle wherein the body comprises a resin matrix with a plurality of bubbles encased therein.

In brief summary, the method of the invention provides a means for forming an insulative body as described herein, the method comprising (1) applying a forming composition comprising a curable resin and a plurality of durable bubbles to a substrate and (2) curing the resin to encase the bubbles therein.

Materials of the invention can be applied thickly, if desired, exhibit reduced weight, and improved accoustic and temperature insulation. Materials of the invention can be used to provide improved impact resistance and energy absorption, e.g., protecting damage to vehicle body components such as the surfaces of a cargo area, in the event of explosion. Materials of the invention can be used to provide protection against blast forces as well.

### DETAILED DESCRIPTION OF ILLUSTRATIVE EMBODIMENTS

Coating compositions of the invention comprise a reactive resin formulation that is applied to a substrate and then cures, i.e., cures in situ, to form a cured resin matrix. Illustrative examples include two part polyurethane and two part polyurea formulations. Typically, polyurea formulations are preferred as they tend to cure more rapidly than polyurethane systems. Many suitable reactive precursors are known and suitable selections for particular applications can be readily made by those skilled in the art.

Coating compositions of the invention comprise hollow microspheres. Illustrative examples include microspheres or bubbles made from glass, ceramics, and in some embodiments, plastic.

In some embodiments, the composition may typically include up to about 35 weight percent of the microspheres, in other embodiments the composition will typically include up to about 25 weight percent of the microspheres, preferably from about 5 to about 20 weight percent. Higher loadings may be used if desired, however, the viscosity of the coating composition may tend to increase undesirably so as to make the composition difficult to handle and apply.

Typically the microspheres will be up to about 225 microns in diameter, typically preferably the microspheres will have an average diameter of about 20 to about 85 microns. It is typically desired that the microspheres in a composition be of a distribution in the indicated size domain such that higher packing of microspheres in the final coating is achieved.

Typically the microspheres will have a density of under about 1 gram/centimeter³ though in some embodiments microspheres having higher density, e.g., up to about 2.5 gram/centimeter³ may be used.

The microspheres should be sufficiently strong to withstand the mixing and spraying operations used to mix and apply the reactive resin components to the substrate. Typically the resin is a two part system (e.g., an amine precursor and an isocyanate precursor) that is mixed immediately before application to the substrate. In accordance with the present invention, the microspheres may be mixed in one or both the two resin precursors prior to mixing of the resin precursors or the microspheres may be mixed into the resin components at the time the precursors are themselves mixed or applied to the substrate. Accordingly, the microspheres should be sufficiently robust to survive the application process. Typically, the microspheres will preferably have a crush strength of at least about 3000 pounds/inch². In some embodiments, stronger microspheres, e.g., having a crush strength of at least about 5000 or even 10,000 pounds/inch² may be desired.

High build coatings of the invention can be used in many locations as desired. In a typical embodiment, the coating material is applied to cargo bed of the vehicle as a bed liner. In addition, it can be applied at other locations, e.g., as a floor liner in the passenger cabin, as a filler in interstices of the vehicle body, as an insulative coating on exterior portions of the passenger cabin and/or cargo area.

Incorporation of bubbles in the resin matrix as described herein has been surprisingly found to increase the retention of paint coatings on the coating as well as to improve the machinability properties of the coating as compared to coatings made with the same reactive resin precursors but without incorporation of the bubbles.

Embodiments of the present invention may be made with such substrates as metal articles, glass, plastic, cementatious materials, wood, cerarmic materials, fabrics, foams, non-wovens, etc.

In addition to spray applied coatings, compositions of the invention may be used in spray molding operations where after curing the high build coating is removed from the substrate having a desired defined shape imparted from the substrate.

### EXAMPLES

The invention will be further explained by the following illustrative examples which are intended to be non-limiting. Unless otherwise indicated, all amounts are expressed in parts by weight.

Unless otherwise indicated, the following test methods were used.

Test Methods

Thermal Conductivity Test Method 1

Thermal conductivity was measured using a Model 2021 Thermal Conductivity Apparatus (available from Anter Corporation, Pittsburgh, Pa.) following ASTM E 1530 (Test Method for Evaluating the Resistance to Thermal Transmission of Thin Specimens of Materials by the Guarded Flow Meter Technique).

Hot Face vs. Cold Face Test Method 2

A 4 inch×6 inch (10.16 cm×15.24 cm) rectangular hole was cut in the top of a lab furnace (Econo-Kiln, Model K 14, L & L Manufacturing Co., Twin Oaks, Pa.; maximum temperature of 1832° F. (1000° C.)). The sample to be tested was placed over the rectangular hole in the furnace such that the edges of the sample fully overlapped on all sides of the opening. Two thermocouples (Type K Thermocouple Thermometer, Model 650, Omega Engineering, Inc., Stamford, Connecticut) were placed in the center of the sample and held in contact with a foil tape. One thermocouple measures the external face temperature (T_{Outside}) of the sample (that portion outside the oven) and one thermocouple measures the internal face temperature T_{Inside} of the sample (that portion inside the furnace). The furnace oven was turned on and the T_{Inside} of the sample was adjusted to 200° F. (93.3° C.) or 250° F. (121° C.), as designated in the Examples below. After several minutes, the T_{Outside} was recorded. In some cases, an infrared camera (available from Flir Systems Inc., Portland, Oreg., under the trade designation “THERMACAM™ P65”) was used to record the temperature, designated T_{infrared}, of the external face surface of the sample (See Tables 5 and 6).

Thermal Conductivity Test Method 3

Thermal conductivity was measured using a thermal conductivity apparatus (available from LaserComp, 20 Spring St. Saugus, Me., under the trade designation “FOX50™ SERIES”) following ASTM C 518 and ISO 8301 (Designed for testing the thermal conductivity of materials in the conductivity range of 0.1 W/mK to 10 W/mK). The temperature range used was 85° C. to 110° C. The average temperature of 97.5° C. is the temperature the data point was measured. Sample sizes tested were 56 mm in diameter.

Density Test Method 4

Density was measured using a gas pycnometer (available from Micromeritics, Norcross, Georgia, under the trade designation “ACCU PYC™ 1330”). Samples were measured using the 109 mL cup.

Shore Hardness Test Method 5

Shore Hardness was measured using a Shore Instrument and Manufacturing Co. Model Shore “A” and Shore “D” (available from Instron Corporation, Norwood, Mass.) following ASTM D 2240-05 (Durometer (Shore) Hardness Test Method).

Taber Abrasion Test Method 6

Taber Abrasion was measured using a Taber Abraser Model 5150 (available from Taber Industries, North Tonawanda, N.Y.) following ASTM D 4060-01 (Taber Abraser Test Method).

Accelerated Weathering Test Method 7

Accelerated weathering was performed following ASTM Test Method GI 55 with a total duration of 3,000 hours and a cycle time of 2 hours. The samples were first subjected to 84 minutes of intense xenon light. Next, the samples were subjected to 36 minutes of xenon light, and distilled water spray. Each sample was then subjected to 1,500 cycles.

### Example 1

A two component polyurea (Part A and Part B) was formulated as follows. Part A contained hexamethylene diisocyanate (85.2% by weight, obtained from Rhodia, Inc., Cranbury, N.J., under the trade designation “TOLONATETM HDT LV2”), glass microspheres (13.5 % by weight, obtained from 3M Company under the trade designation “3M™ GLASS MICROSPHERES K37”) and a modified polyurea (1.3% by weight, obtained from BYK Chemie, Wesel, Germany, under the trade designation “BYK™ 410”). Part B contained diethyltoluenediamine (32.4% by weight, obtained from Albemarle Corporation, Bayport, Tex., under the trade designation “ETHACURE™ 100”), polyoxypropylenediamine (39.6% by weight, obtained from Huntsman Corporation, Salt Lake City, Utah under the trade designation “JEFFAMINE™ D-2000”), an aromatic secondary diamine (6.5% by weight, obtained from UOP, A Honeywell Company, Tonawanda, N.Y., under the trade designation “UNILINK™ 4200”), a trifunctional amine (2.4% by weight, obtained from Huntsman Corporation under the trade designation “JEFFAMINE™ T-5000”), glass microspheres (18.2% by weight, obtained from 3M Company under the trade designation “3M™ GLASS MICROSPHERES K37”), a modified polyurea (0.8% by weight, obtained from BYK Chemie, under the trade designation “BYK™ 410”) and a liquid organic pigment to produce the desired color (0.1%). Parts A and B are hereinafter designated L-19990A/L1999GB 2100.

Parts A and B were sprayed from a plural component proportioning sprayer (obtained from Graco, Minneapolis, Minn., under the trade designation “REACTOR H-XP2” using a “FUSION AP” spray gun with nozzles. Each part (A and B) was kept separate until they exited the spray gun. The two components, A and B, were stirred, in separate pots, in the spray unit and maintained at a temperature of 160° F. (71° C.) during the spray process. The materials (Parts A and B) were sprayed on to a cold roll steel panel that was previously sprayed with a release agent (from Sierra Paint Co., Minnetonka, Minn., under the trade designation “TK-709 UR”) and also waxed paper. The formulation cured within about 20 seconds. After a period of time the sprayed panels were peeled from the metal substrate and waxed paper and tested as described above using Test Method 2 and 3. Resulting data is listed in Table 1.

### Example 2

A two component polyurea (Part A and Part B) was formulated as follows. Part A contained hexamethylene diisocyanate (85.2% by weight, obtained from Rhodia, Inc. under the trade designation “TOLONATE™ HDT LV2”), glass microspheres (13.5% by weight, obtained from 3M Company under the trade designation “3M™ GLASS MICROSPHERES K37”) and a modified polyurea (1.3% by weight, obtained from BYK Chemie under the trade designation “BYK™ 410”). Part B contained diethyltoluenediamine (31.6% by weight, obtained from Albemarle Corporation, Bayport, Tex., under the trade designation “ETHACURE 100”), polyoxypropylenediamine (38.7% by weight, obtained from Huntsman Corporation, Salt Lake City, Utah, under the trade designation “JEFFAMINE™ D2000”), an aromatic secondary diamine (6.3% by weight, obtained from UOP, A Honeywell Company, Tonawanda, N.Y. under the trade designation “UNILINK™ 4200”), a trifunctional amine (2.4% by weight, obtained from Huntsman Corporation under the trade designation “JEFFAMINE™ T-5000”), glass microspheres (17.8% by weight, obtained from 3M Company under the trade designation “3M™ GLASS MICROSPHERES K37”), a modified polyurea (0.7% by weight, obtained from BYK Chemie, under the trade designation “BYK™ 410”), deionized water (2.4% by weight) and a liquid organic pigment to produce the desired color (0.1%). Parts A and B are hereinafter designated L-19990A/L1999GB 2100H.

Parts A and B were sprayed from a plural component proportioning sprayer (obtained from Graco Corporation, Minneapolis, Minn., under the trade designation “REACTOR H-XP2” using a “FUSION AP” spray gun with nozzles. Each part (A and B) was kept separate until they exited the spray gun. The two components, A and B, were stirred, in separate pots, in the spray unit and maintained at a temperature of 160° F. (71° C.) during the spray process. The materials (Parts A and B) were sprayed on to a cold roll steel panel that was previously sprayed with a release agent (from Sierra Paint Co. under the trade designation “TK-709 UR”) and also waxed paper. The formulation cured within about 20 seconds. After a period of time the sprayed panels were peeled from the metal substrate and waxed paper and tested as described above using Test Method 2 and 3. Resulting data is listed in Table 1.

TABLE 1

| Test Method | Example 1 | Example 2 |
|---|---|---|
| Test Method | 250° F./115° F. | 250° F./104° F. |
| 2 - Hot Face vs. | | |
| Cold Face | | |
| Thermal | K = 0.1 W/mK @ 58° C. | K = 0.07 W/mK @ 58° C. |
| Conductivity Test | | |
| Method 1 | | |

### Preparation of Examples 3-12

### Example 3

An insulation mat (available from 3M Company, St Paul, Minn., under the trade designation “THINSULATE™ AU6020-6 INSULATION”) was sprayed with glass filled polyurea (available from 3M Company, St Paul, Minn., under the trade designation “L-19990A/L19990GB 2100”) with a plural-component spray equipment reactor Model H-XP2 (available from Graco Corporation, Minneapolis, Minn.). The sample was sprayed with 3 coats, yielding a final coating that was 0.125 inch (3.2 mm) thick on each side. The sample was tested using Test Method 2 described above to determine the hot face/cold face temperature. Results are listed in Table 2.

### Example 4

A 0.25 inch thick (6.35 mm) molded polyurethane sheet (available from Epoxical Incorporated, South St Paul, Minn.) was sprayed with glass filled polyurea (available from 3M Company, St Paul, Minn., under the trade designation “L-19990A/L19990GB 2100”) with a plural-component spray equipment reactor Model H-XP2 (available from Graco Corporation). Sample was sprayed with 3 coats, yielding a final coating that was ⅛ inch (3.2 mm) thick on each side. The sample was tested using Test Method 2 described above to determine the hot face/cold face temperature. Results are listed in Table 2.

### Example 5

A 0.5 inch thick (12.7 mm) polyisocyanurate insulation sheet (available from Dow Chemical Company, Midland, Mich., under the trade designation “SUPER TUFF-R™”) was sprayed with glass filled polyurea (available from 3M Company, St Paul, Minn., under the trade designation “L-19990A/L19990GB 2100”) with a plural-component spray equipment reactor Model H-XP2 (available from Graco Inc Corporation, Minneapolis, Minn.). The sample was sprayed with 3 coats, yielding a final coating that was ⅛ inch (3.2 mm) thick on each side. The sample was tested using Test Method 2 described above to determine the hot face/cold face temperature. Results are listed in Table 2.

### Example 6

A 0.25 inch thick (6.35 mm) polystyrene insulation sheet (available from Owens Corning Company, Toledo, Ohio, under the trade designation “FANFOLD™”) was sprayed with glass filled polyurea (available from 3M Company, St Paul, Minn., under the trade designation “L-19990A/L19990GB 2100”) with a plural-component spray equipment reactor Model H-XP2 (available from Graco Corporation, Minneapolis, Minn.). The sample was sprayed with 3 coats, yielding a final coating that was ⅛ inch (3.2 mm) thick on each side. The sample was tested using Test Method 2 described above to determine the hot face/cold face temperature.

### Example 7

A 0.125 inch (3.2 mm) aluminum panel (available from Ryerson Company, Minneapolis, Minn., under the trade designation “6061 T 651 aluminum”) coated with “TK-709 UR” form oil (available from Sierra Corporation, Minnetonka, Minn.) was sprayed with glass filled polyurea (available from 3M Company, St Paul, Minn., under the trade designation “L-19990A/L19990GB 2100”) with a plural-component spray equipment reactor Model H-XP2 (available from Graco Inc Corporation, Minneapolis, Minn.). The sample was sprayed with 6 coats, yielding a final coating that was 0.25 inch (6.35 mm) thick after being removed from the aluminum. The sample was tested using Test Method 2 described above to determine the hot face/cold face temperature. Results are listed in Table 2.

### Example 8

A 0.125 inch (3.2 mm) aluminum panel (available from Ryerson Company, Minneapolis, Minn., under the trade designation “6061 T 651 ALUMINUM”) coated with “TK-709 UR” form oil (available from Sierra Corporation, Minnetonka, Minn.) was sprayed with glass filled polyurea (available from 3M Company, St Paul, Minn., under the trade designation “L-19990A/L19990GB 2100”) with a plural-component spray equipment reactor Model H-XP2 (available from Graco Inc Corporation, Minneapolis, Minn.). The sample was sprayed with 6 coats, yielding a final coating that was 0.25 inch (6.35 mm) thick after being removed from the aluminum. The sample was tested using Test Method 2 described above to determine the hot face/cold face temperature. Results are listed in Table 2.

### Example 9

A 0.25 inch thick (6.35 mm) mat (available from 3M Company, St Paul, Minn., under the trade designation “INTERAM™ 900HT MAT”) was laminated on one side to a 0.005 inch (0.13 mm) thick embossed aluminum foil (available from All-Foils, Inc, Cleveland, Ohio) using as spray adhesive (available from 3M Company, St. Paul, Minn., under the trade designation “3M HIGH STRENGTH 90™ SPRAY ADHESIVE”) and was sprayed with glass filled polyurea (available from 3M Company, St Paul, Minn., under the trade designation “L-19990A/L19990GB 2100”) with a plural-component spray equipment reactor Model H-XP2 (available from Graco Inc Corporation, Minneapolis, Minn.). The sample was sprayed with 3 coats, yielding a final coating that was 0.125 inch (3.2 mm) thick on all sides except the foil side. The sample was tested with the foil side as the hot side using Test Method 2 described above to determine the hot face/cold face temperature. Results are listed in Table 2.

### Example 10

A 0.125 inch (3.2 mm) aluminum panel (available from Ryerson Company, Minneapolis, Minn., under the trade designation “6061 T 651 ALUMINUM”) coated with “TK-709 UR” form oil (available from Sierra Corporation) was sprayed with glass filled polyurea (available from 3M Company under the trade designation “L-19990A/L19990GB 2100”) with a plural-component spray equipment reactor Model H-XP2 (available from Graco Corporation). The sample was sprayed with 6 coats, yielding a final coating that was ¼ inch (6.35 mm) after being removed from the aluminum. The sample was tested with the foil side as the hot side using Test Method 2 described above to determine the hot face/cold face temperature. Results are listed in Table 2.

### Example 11

A 0.125 inch (3.2 mm) aluminum panel (available from Ryerson Company, Minneapolis, Minn., under the trade designation “6061 T 651 aluminum”) coated with “TK-709 UR” form oil (available from Sierra Corporation, Minnetonka, Minn.) sprayed with glass filled polyurea (available from 3M Company under the trade designation “L-19990A/L19990GB 2100”) with a plural-component spray equipment reactor Model H-XP2 (available from Graco Corporation). The sample was sprayed with 6 coats, yielding a final coating that was 0.25 inch (6.5 mm) thick after being removed from the aluminum. The sample was tested with the foil side as the hot side using Test Method 2 described above to determine the hot face/cold face temperature. Results are listed in Table 2.

### Example 12

A 0.125 inch (3.2 mm) aluminum panel (available from Ryerson Company, Minneapolis, Minn., under the trade designation “6061 T 651 aluminum”) coated with TK-709 UR Form Oil (available from Sierra Corporation, Minnetonka, Minn.) was sprayed with 3M Glass Filled Polyurea L-19990A/L19990GB-2100H (foaming) (glass bubbles replaced with ceramic beads (available from 3M Company under the trade designation “ZEEOSPHERES™ CERAMIC MICROSPHERES G-200”) with a plural-component spray equipment reactor Model H-XP2 (available from Graco Corporation). The sample was sprayed with 6 coats, yielding a final coating that was 0.31 inch (7.9 mm) thick after being removed from the aluminum. The sample was tested with the foil side as the hot side using Test Method 2 described above to determine the hot face/cold face temperature. Results are listed in Table 2.

TABLE 2
Hot Face vs. Cold Face Temperature; Test Method 2

| | Thermocouple | Thermocouple |
|---|---|---|
| | Temp inside | Temp (outside |
| Example | furnace ° F. (° C.) | furnace) ° F. (° C.) |
| 3 | 250 (121.1) | 91 (32.8) |
| 4 | 250 (121.1) | 112 (44.4) |
| 5 | 249 (120.6) | 86 (30.0) |
| 6 | 251 (121.7) | 87 (30.6) |
| 7 | 249 (120.6) | 115 (46.1) |
| 8 | 249 (120.6) | 104 (40.0) |
| 9 | 240 (115.6) | 93 (33.9) |
| 10 | 250 (121.1) | 135 (57.2) |
| 11 | 250 (121.1) | 107 (41.7) |
| 12 | 250 (121.1) | 126 (52.2) |

### Examples 13-15

### Example 13

An insulation mat (available from 3M Company under the trade designation “THINSULATE™ AU6020-6 INSULATION”) and a window film (available from 3M Company under the trade designation “3M™ SPR-70 PRESTIGE WINDOW FILM”) was sprayed with 3M glass filled polyurea (available from 3M Company under the trade designation “L-19990A/L19990GB-2100H” (foaming) ) with a plural-component spray equipment reactor Model H-XP2 (available from Graco Corporation). Sample was sprayed with 3 coats, yielding a final coating that was 0.125 inch (3.2 mm) thick on each side.

### Example 14

A 0.25 inch (6.35 mm) aluminum panel (available from Ryerson Company under the trade designation “6061 T 651 aluminum”). A clear ultra high performance PET Micro-layered Film safety and security window film (cut one inch shorter on all sides compared with the dimensions of the aluminum panel; available from 3M Company, St Paul, Minn., under the trade designation “3M SCOTCHSHIELD™ ULTRA 600”) was sprayed with 3M glass filled polyurea (available from 3M Company under the trade designation “L-19990A/L19990GB 2100”) with a plural-component spray equipment reactor Model H-XP2 (available from Graco Corporation). Sample consisted of the construction: aluminum panel, coating, film, coating, film, coating, film and coating. Sample was sprayed with several coats, yielding a final coating that was 0.25 inch (6.35 mm) thick for each layer.

### Example 15

A 0.25 inch thick (6.35 mm) insulation mat (available from Thermal Ceramics, Augusta, Ga., under the trade designation “FLEXIBLE MIN-K™ BL27184-8”) was laminated on one side to a 0.005 inch (0.13 mm) thick embossed aluminum foil (available from All-Foils, Inc, Cleveland, Ohio) using as spray adhesive (available from 3M Company under the trade designation “3M HIGH STRENGTH ₉₀™ SPRAY ADHESIVE”) and was sprayed with glass filled polyurea (available from 3M Company under the trade designation “L-19990A/L19990GB-2100H” (foaming)) with a plural-component spray equipment reactor Model H-XP2 (available from Graco Corporation). The mat was sprayed with 3 coats, yielding a final coating that was 0.125 inch (3.2 mm) thick on all sides, except the foil side.

### Examples 16, 17 and 20 and Comparative Examples C7 and C8

### Example 16

A 0.125 inch (3.2 mm) aluminum panel (available from Ryerson Company under the trade designation “6061 T 651 aluminum”) coated with “TK-709 UR” form oil (available from Sierra Corporation) sprayed with glass filled polyurea (available from 3M Company under the trade designation “L-19990A/L19990GB-2100”) with a plural-component spray equipment reactor Model H-XP2 (available from Graco Corporation). Sample was sprayed with 6 coats, yielding a final coating that was 0.25 inch (6.35 mm) thick after being removed from the aluminum. The sample was tested using Test Method 3, 4, 5 and 6 described above to determine the thermal conductivity, density, Shore hardness and Taber Abrasion. Results are listed in Table 3 below.

### Example 17

A 0.125 inch (3.2 mm) aluminum panel (available from Ryerson Company under the trade designation “6061 T 651 aluminum”) coated with “TK-709 UR” form oil (available from Sierra Corporation) was sprayed with glass filled polyurea (available from 3M Company under the trade designation “L-19990A/L19990GB-2100H” (foaming)) with a plural-component spray equipment reactor Model H-XP2 (available from Graco Corporation). The sample was sprayed with 6 coats, yielding a final coating that was 0.25 inch (6.35 mm) thick after being removed from the aluminum. The sample was tested using Test Method 3, 4, 5 and 6 described above to determine the thermal conductivity, density, Shore hardness and Taber Abrasion. Results are listed in Table 3 below.

### Comparative Example C7

A 0.125 inch (3.2 mm) aluminum panel (available from Ryerson Company under the trade designation “6061 T 651 aluminum”) coated with “TK-709 UR” form oil (available from Sierra Corporation) was sprayed with polyurea (available from 3M Company under the trade designation “L-19990A/L19990GB 2100” without glass bubbles added) with a plural-component spray equipment reactor Model H-XP2 (available from Graco Corporation). The sample was sprayed with 6 coats, yielding a final coating that was 0.25 inch (6.35 mm) after being removed from the aluminum. The sample was tested using Test Method 3, 4, 5 and 6 described above to determine the thermal conductivity, density, Shore hardness and Taber Abrasion. Results are listed in Table 3 below.

### Comparative Example C8

A 0.125 inch (3.2 mm) aluminum panel (available from Ryerson Company under the trade designation “6061 T 651 aluminum”) coated with “TK-709 UR” form oil (available from Sierra Corporation) was sprayed with 3M Glass Filled Polyurea L-19990A/L19990GB-2100H (foaming) (without glass bubbles added) (available from 3M Company) with a plural-component spray equipment reactor Model H-XP2 (available from Graco Corporation). The sample was sprayed with 6 coats, yielding a final coating that was 0.25 inch (6.5 mm) thick after being removed from the aluminum. The sample was tested using Test Method 3, 4, 5 and 6 described above to determine the thermal conductivity, density, Shore hardness and Taber Abrasion. Results are listed in Table 3 below.

### Example 20

A 0.125 inch (3.2 mm) aluminum panel (available from Ryerson Company under the trade designation “6061 T 651 aluminum”) coated with “TK-709 UR” form oil (available from Sierra Corporation) was sprayed with 3M Glass Filled Polyurea L-19990A/L19990GB-2100H (foaming) (glass bubbles replaced with ceramic beads (available from 3M Company under the trade designation “ZEEOSPERE™ CERAMIC MICROSPHERES G-200”) with a plural-component spray equipment reactor Model H-XP2 (available from Graco Corporation). Sample was sprayed with 6 coats, yielding a final coating that was 0.31 inch (7.9 mm) thick after being removed from the aluminum. The sample was tested using Test Method 3, 4, 5 and 6 described above to determine the thermal conductivity, density, Shore hardness and Taber Abrasion. Results are listed in Table 3 below.

TABLE 3

| | Thermal | | | | % Weight |
|---|---|---|---|---|---|
| | Conductivity | Density | Shore “A” | Shore “D” | Loss |
| Example | W/mK | g/cc | Hardness | Hardness | (Taber) |
| 16 | 0.148 | 0.7876 | 96-99 | 60-75 | 0.040 |
| 17 | 0.106 | 0.5866 | 95-100 | 55-60 | 0.095 |
| C7 | 0.161 | 1.0019 | 94-97 | 64-68 | 0.038 |
| C8 | 0.117 | 0.8829 | 92-97 | 59-63 | 0.086 |
| 20 | 0.165 | 1.0571 | 95-98 | 68-72 | 0.095 |

### Preparation of Examples 21-29 and Comparative Examples C1-C3

Examples 21-29 and Comparative Examples C1-C3 were prepared using the following method. Glass bubbles (available from 3M Company, under the trade designation “3M™ Glass Bubbles”) were mixed by hand into polyurethane based truck bed liner (obtained from Old World Industries, Northbrook, Ill. under the trade designation “HERCULINER™ TRUCK BED LINER”) using amounts specified in Table 4. Comparative Examples C1-C3 contained no glass bubbles, only polyurethane based truck bed liner. Once uniformly mixed, each formulation was applied in three coats, by pouring and brushing, onto a silicone release liner, yielding a final coating that was ⅛ inch (3.2 mm) thick. The samples were allowed to set for 8 days and the top surface of the polyurethane based bed liner samples were sanded smooth using 100 grit sandpaper (available from 3M Company, under the trade designation “3M™ PRODUCTION RESINITE™ GOLD SHEET”). After removing the samples from the silicone release paper, the samples were tested using Thermal Conductivity Test Method 1 described above to determine thermal conductivity.

TABLE 4
Thermal Conductivity; Test method 1

| | | | Thermal |
|---|---|---|---|
| | Loading of | | Conductivity |
| Example | Bubbles (wt. %) | Temperature (° C.) | (K − (Wm/K)) |
| C1 | *N/A | 35 | 0.19 |
| C2 | N/A | 55 | 0.20 |
| C3 | N/A | 75 | 0.21 |
| 21 | 10 | 37 | 0.14 |
| 22 | 10 | 53 | 0.15 |
| 23 | 10 | 73 | 0.16 |
| 24 | 20 | 39 | 0.13 |
| 25 | 20 | 52 | 0.14 |
| 26 | 20 | 72 | 0.15 |
| 27 | 25 | 38 | 0.12 |
| 28 | 25 | 52 | 0.14 |
| 29 | 25 | 73 | 0.14 |

*N/A means no bubbles were added

### Preparation of Examples 30-34 and Comparative Example C4

Examples 30-34 and Comparative Example C4 were prepared using the following method. Glass bubbles (available from 3M Company under the trade designation “3M™ K37 Glass Bubbles”) were mixed by hand into polyurethane based truck bed liner (obtained from Old World Industries, Northbrook, Ill. under the trade designation “HERCULINER™ TRUCK BED LINER”) using the amounts specified in Table 5. Comparative Example C4 contained no polyurethane based truck bed liner, only the steel backing. Once uniformly mixed, each formulation was applied in three coats, by pouring and brushing, onto a 22 gauge steel plate (8 inch×8 inch×0.028 in (20.3 cm×20.3 cm×0.71 mm)), yielding a final coating thicknesses listed in Table 2. The samples were allowed to set for 8 days. The samples were tested facing the steel side of the samples toward the furnace using Thermal Conductivity Test Method 2 described above to determine the hot face vs. cold face temperatures.

TABLE 5
Hot Face vs. Cold Face Temperatures;
Test Method 2; Steel side toward furnace.

| | Sample | | | | |
|---|---|---|---|---|---|
| | Thickness | Loading of | T_{Inside} | To_{Outside} | T_{Infrared} |
| Ex | inches (mm) | Bubbles wt. % | ° F. (° C.) | ° F. (° C.) | ° F. (° C.) |
| C4 | 0.028 (0.71 | *N/A | 200 (93.3) | 151 (66.1) | 177 (80.6) |
| | steel) | | | | |
| 30 | 0.08 (2.03) | 9.75 | 200 (93.3) | 126 (52.2) | 126 (52.2) |
| 31 | 0.10 (2.54) | 15.00 | 201 (93.9) | 124 (51.1) | 118 (47.8) |
| 32 | 0.13 (3.30) | 22.50 | 201 (93.9) | 124 (51.1) | 117 (47.2) |
| 33 | 0.15 (3.81) | 30.00 | 201 (93.9) | 120 (48.9) | 114 (45.6) |
| 34 | 0.16 (4.06) | 35.25 | 200 (93.3) | 122 (50.0) | 115 (46.1) |

*N/A means steel plate only

### Preparation of Examples 35-39 and Comparative Example C5

Examples 35-39 and Comparative Example C5 were prepared using the following method. Glass bubbles (available from 3M Company under the trade designation “3M™ K37 Glass Bubbles”) were mixed by hand into polyurethane based truck bed liner (obtained from Old World Industries, Northbrook, Ill. under the trade designation “HERCULINER™ TRUCK BED LINER”) using the amounts specified in Table 6. Comparative Example C4 contained no polyurethane based truck bed liner, only the steel backing. Once uniformly mixed, each formulation was applied in three coats, by pouring and brushing, onto a 22 gauge steel plate (8 inch 8 inch×0.028 in (20.3 cm×20.3 cm×0.71 mm)), yielding a final coating thicknesses listed in Table 3. The samples were allowed to set for 8 days. The samples were tested facing the coated polyurethane truck bed liner side of the samples toward the furnace using test Method 2 described above to determine the hot face vs. cold face temperatures.

### Preparation of Examples 40-41 and Comparative Examples C5 and C6

Examples 20-21 and Comparative Examples C5 and C6 were prepared using the following method. Glass bubbles (available from 3M Company, under the trade designation “3M™ K37 Glass Bubbles”) were mixed by hand into an aliphatic polyurethane based coating (obtained from 3M Company under the trade designation “3M™ SCOTHCLAD™ TC SELF-LEVELING BASE COAT”) using the amounts specified in Table 3. Once uniformly mixed, each formulation was applied in one coat, by pouring and brushing, onto a silicone release liner. After allowing to set for 24 hours, the final (dry) coating thickness was measured using a handheld caliper device and is listed in Table 6. After removing the samples from the silicone release paper, the samples were tested using Test Method 2 described above to determine the hot face vs. cold face temperatures.

TABLE 6
Hot face vs. Cold Face Temperatures; Test Method 2;
Coated Polyurethane based truck bed liner side toward furnace.

| | Sample | | | | |
|---|---|---|---|---|---|
| | Thickness | Loading of | T_{Inside} | T_{Outside} | T_{Infrared} |
| Ex | inches | Bubbles wt. % | ° F. (° C.) | ° F. (° C.) | ° F. (° C.) |
| C5 | 0.028 (steel) | *N/A | 200 (93.3) | 151 (66.1) | 177 (80.6) |
| 35 | 0.08 | 9.75 | 203 (95.0) | 145 (62.8) | 141 (60.6) |
| 36 | 0.10 | 15.00 | 202 (94.4) | 142 (61.1) | 129 (53.9) |
| 37 | 0.13 | 22.50 | 203 (95.0) | 136 (57.8) | 116 (46.7) |
| 38 | 0.15 | 30.00 | 202 (94.4) | 134 (56.7) | 104 (40.0) |
| 39 | 0.16 | 35.25 | 203 (95.0) | 131 (55.0) | 106 (41.1) |
| C6 | 0.45 | *N/A | 202 (94.4) | 122 (50.0) | 112 (44.4) |
| 40 | 0.46 | 10.0 | 201 (93.9) | 120 (49.4) | 110 (43.3) |
| 41 | 0.52 | 20.0 | 203 (95.0) | 120 (48.9) | 107 (41.7) |

*N/A means no bubbles were included in the formulation.

### Preraration of Examples 42-44

Example 42 was prepared using the following method. Glass bubbles (available from 3M Company under the trade designation “3M K37 Glass Bubbles”) were mixed by hand into a polurethane based coating (available from 3M Company under the trade designation “3M Scotch-Clad TC Top Coat B/A”), yielding a 20 weight percent glass bubbles. Once uniformly mixed, it was applied by pouring into an aluminum pan (8 inch×8 inch×0.028 in (20.3 cm×20.3 cm×0.71 mm)), yielding a final coating thickness 0.5 inch (12.7 mm). The samples were allowed to set for 1 day. The sample was tested using Test Method 2 described above to determine the hot face/cold face temperature. Results are listed in Table 7.

Example 43 was prepared using the following method. Glass bubbles (available from 3M Company, under the trade designation “3M™ K37 Glass Bubbles”) were mixed by hand into a polyurethane based coating (available from 3M Company under the trade designation “3M Scotch-Clad TC Top Coat B/A”), yielding a 20 weight percent glass bubbles. Once uniformly mixed, it was applied by pouring into an aluminum pan (8 inch×8 inch×0.028 in (20.3 cm×20.3 cm×0.71 mm)) which included a ceramic woven fabric (available from 3M Company under the trade designation “3M™ Nextel™ 312 AF-62 Woven Fabric”), yielding a final coating thickness 0.5 inch (12.7 mm) with the fabric encapsulated. The samples were allowed to set for 1 day. The sample was tested using Test Method 2 described above to determine the hot face/cold face temperature. Results are listed in Table 7.

Example 44 was prepared using the following method. Glass bubbles (available from 3M Company, under the trade designation “3M™ K37 Glass Bubbles”) were mixed by hand into a polyurethane based coating (available from 3M Company under the trade designation “3M Scotch-Clad TC Top Coat B/A”), yielding a 20 weight percent glass bubbles. Once uniformly mixed, it was applied by pouring into an aluminum pan (8 inch×8 inch×0.028 inch (20.3 cm×20.3 cm×0.71 mm)) which included a ceramic non-woven mat (available from 3M Company, under the trade designation “3M™ NEXTEL™ 610 Paper XN-858”), yielding a final coating thickness 0.5 inch (12.7 mm) with the paper encapsulated. The samples were allowed to set for 1 day. The sample was tested using Test Method 2 described above to determine the hot face/cold face temperature. Results are listed in Table 7.

TABLE 7
Thermal Conductivity Hot Face vs. Cold Face Test Method 2

| | Thermocouple | Thermocouple |
|---|---|---|
| | Temp inside | Temp (outside |
| Example | furnace ° F. (° C.) | furnace) ° F. (° C.) |
| 42 | 251 (121.7) | 135 (57.2) |
| 43 | 250 (121.1) | 120 (48.9) |
| 44 | 251 (121.7) | 121 (49.4) |

### Example 45

A 0.125 inch (3.2 mm) aluminum panel (available from Ryerson Company under the trade designation “6061 T 651 aluminum”) was sprayed with glass filled polyurea (available from 3M Company under the trade designation “L-19990A/L 19990GB 2100”) with a plural-component spray equipment reactor Model H-XP2 (available from Graco Corporation). The sample was sprayed with 3 coats, yielding a final coating that was 0.125 inch (3.2 mm) thick on both sides. Accelerated weathering Test Method 7 was performed on the sample. Upon completion of the weathering test, a visual inspection of the sample was conducted. The weathered, coated panel showed only very minor signs of weathering. The weathered coated panel looked similar to the coated panel before being subjected to accelerated weathering Test Method 7.

Various modifications and alterations of this invention will become apparent to those skilled in the art without departing from the scope and spirit of this invention.

What is claimed is:

1. A coating on a substrate comprising an in situ cured resin matrix with a plurality of bubbles therein.

2. The coating of claim 1 wherein said bubbles are hollow microspheres.

3. The coating of claim 2 wherein said bubbles are glass microspheres.

4. The coating of claim 3 wherein said glass microspheres have a crush strength of at least about 3000 pounds/inch².

5. A motor vehicle comprising a coating of claim 1 on a portion thereof.
